(19) United States
(12) Patent Application Publication
(10) Pub. No.: US 2011/0136251 A1
(43) Pub. Date: Jun. 9, 2011

(54) ANALYTE RECOVERY FROM DRIED BLOOD SPOTS

(76) Inventor: Thomas W. Astle, Orange, CT (US)

(21) Appl. No.: 12/952,432

(22) Filed: Nov. 23, 2010

Related U.S. Application Data
(60) Provisional application No. 61/266,574, filed on Dec. 4, 2009.

(51) Int. Cl. G01N 1/28; B01L 3/02

(52) U.S. Cl. 436/178; 422/524; 422/513

(57) ABSTRACT

Pipette tips, pipetting system and methods for eluting an analyte from a solid phase filtration media that resides within an upper portion of the pipette tips. Each pipette tip includes an upper barrel containing and retaining the solid phase filtration media and a lower cannula. The solid phase filtration media resides between the upper barrel and the lower cannula. An eluting solvent is provided into the pipette tips for eluting the analyte from the solid phase filtration media by soaking, ultrasonic agitation or agitation by mixing. A sorbent material may reside within the cannula portion of each pipette tip for filtering or treating the eluted analyte containing solution prior to it being dispensed from the pipette tip into a microplate for subsequent analytical processing.

### BACKGROUND OF THE INVENTION

1. Field of the Invention

The present invention is directed to dried blood spots, and in particular, to methods and apparatus implementing dried blood spots for various analytical procedures.

2. Description of Related Art

In recent years, the predominant use of dried blood spots (hereinafter referred to as “DBS”) has focused on many DNA applications. Other common uses of DBS are for clinical applications, such as, in neo-natal screening, DNA analysis, disease analyses (infectious disease, blood glucose concentration, etc.), drug screenings, and the like. Preclinical applications for dried blood spots, such as, medical research, drug discoveries, quantitative analysis of drugs in preclinical and clinical studies, and the like, are also becoming more prevalent.

Several advantages to the use of DBS exist including, but not limited to, the decreased volume of blood that is required for analysis. For example, in preclinical applications the reduced blood volume of 10 μL to 20 μL per spot results in fewer animals required for testing. Similar benefits are obtained for clinical applications. For instance, this reduced volume of blood enables the benefit of being able to conduct pediatric studies. DBS are also beneficial for finger prick and/or heel prick blood sampling, as well as for Phase II/III studies in developing countries.

One of the factors that enables the change to smaller volumes of DBS for preclinical and clinical applications is the increasing sensitivity of analyte detection instrumentation (e.g., by Mass Spectroscopy). DBS reduces the sample volume required for analysis, thereby avoiding the need for high volumes of blood, serum, and/or plasma.

However, the analyte must still be extracted from the DBS and presented to the measuring instrumentation in an accommodating form. For instance, a typical acceptably accommodating form is in the liquid phase. A current approach to DBS sampling is to place the DBS within a well of a standard ANSI microplate having up to 96 wells on 9 mm centers in an 8×12 array. A number of liquid phase processing instrumentation are designed to handle these types of microplates.

Once a number of DBS are provided within the wells of the microplate, an aqueous or aqueous/organic liquid is added to each well containing a DBS sample therein. Agitation is then used to assist in the extraction of analyte from the DBS. Depending on the type of sample, this may mean a simple repetitive motion of aspirating and dispensing within the well by a pipettor. However, it has been found that this type of mixing action may, or may not, extract the analyte from the solid support (i.e., from the DBS) into the liquid phase. As such, a problem exists in this approach since the liquid phase may not extract the sample or analyte from the DBS at all, or in a sufficient amount as is required for testing. Another problem exists in separating the liquid phase from the solid support DBS that was used to collect the sample or analyte.

Due to the wide variety of sample sources, in many applications, simple mixing may be insufficient to achieve the desired end result. This necessitates more rigorous methods including prolonged agitation for mixing, or even more rigorous approaches, such as, using external mixing, vortexing, etc.

Once the sample analyte is in a liquid phase, it may need to be “cleaned up” prior to injection into the analyte detection instrumentation (e.g., the LC/MS or LC/MS/MS). This “clean up” step is ultimately dependent upon the specific sample being cleaned, and may include, for instance, filtration processes (e.g., protein precipitation), solid phase extraction, etc.

A disadvantage of these known DBS sample/analyte extraction processes and clean up processes is that multiple disposable elements (e.g., pipette tips, microplates, filter plates, etc.) are required for both processes, and the processes often require multiple steps using a variety of different equipment.

For instance, a conventional analyte extraction often requires punching the DBS, placing it into a first microplate, using a pipette to add extraction fluid, agitate or mix the elute, and then using a pipette to transfer the eluted analyte to another component for sample clean up. This may be another disposable microplate with filter medium for protein precipitation or to another microplate containing solid phase extraction sorbent. In each of these clean up steps, additional pipetting methods are required to condition the sorbent bed.

For instance, in a protein precipitation application an organic fluid is mixed with the extracted analyte to cause the protein constituents to precipitate, which is then passed through a filter medium to separate the precipitate from the liquid phase analyte. Solid phase extraction requires that a sorbent bed first be conditioned by pipetting an organic (e.g., methanol) and then an aqueous solution, followed by passing the liquid phase analyte through the conditioned sorbent bed. Additional pipetting steps may be required, prior to the final step of eluting the analyte from the sorbent bed to the desired destination.

Accordingly, a need exists in the art for improved methods and apparatus that minimize the number of processing steps (e.g., pipetting steps), as well as minimize the amount of equipment and/or disposable elements necessary for eluting and analyzing an analyte or sample from a DBS.

### SUMMARY OF THE INVENTION

Bearing in mind the problems and deficiencies of the prior art, it is therefore an object of the present invention to provide methods and apparatus that minimize the number of processing steps (e.g., pipetting steps) required for eluting and analyzing an analyte or sample from a DBS.

Another object of the present invention is to provide methods and apparatus that minimize the amount of equipment and/or disposable elements necessary for eluting and analyzing an analyte or sample from a DBS.

It is another object of the present invention to provide methods and apparatus for easy and efficient extraction of an analyte or sample from a DBS that simplify and expedite the transfer and introduction of an eluted analyte/sample into analyte detection equipment, e.g., LC/MS, LC/MS/MS, and the like.

Another object of the present invention is to provide methods and apparatus implementing dried blood spots for various analytical procedures that are easily useable, cost effective and allow for faster processing times.

It is yet another object of the present invention to provide methods of making and implementing the pipette tips of the various embodiments of the invention.

Still other objects and advantages of the invention will in part be obvious and will in part be apparent from the specification.

The above and other objects, which will be apparent to those skilled in the art, are achieved in the present invention which is directed to a means of eluting an analyte of interest from a Dried Blood Spots (DBS) whereby the DBS is placed manually or mechanically within a disposable pipette tip. The pipette tip may be used in conjunction with an automated 96 well pipette system of the invention, such as the Quadra™ manufactured by Tomtec Inc. The pipette tip may have a total working volume of 450 μL, of which 90 μL is contained in a lower cannula and the balance in a wider upper barrel. The internal bore connecting the lower cannula to the upper barrel is to be less than 2.0 mm, thereby encasing and retaining the DBS within the upper barrel of the pipette tip when it in turn, is connected to the present pipette system.

The lower cannula of the pipette tip has a length sufficient to reach the bottom of a 96 deep well microplate as defined by the SBS/ANSI Standard. Wherein the lower cannula has a 90 μL capacity, the internal bore of the cannula has a diameter that permits separation of liquid aliquots with a 10 to 15 μL air gap. The upper barrel may have an internal diameter of 4 mm or greater at the point of juncture between the upper barrel and the lower cannula to accommodate a DBS of 4 mm in diameter.

In one or more embodiments, the pipette tips may be connected to an automated pipette system of the invention, which allows a specific volume of elution solvent to be aspirated from a source reservoir into the pipette tips thereby surrounding the DBS contained in the upper barrel of the pipette tip. The aspirated elution solvent may soak the DBS for elution of the analyte of interest from the DBS.

Alternatively, the pipette tips may be subjected to a series of repetitive aspirate and dispense pipetting motions to result in the contained elution solvent to move back and forth through the space occupied by the dried blood spot, thereby eluting the analyte of interest using motion agitation.

As another alternative, the pipette tips containing the DBS with elution solvent may be immersed within an ultrasonic station to transmit ultrasonic frequencies to the tip contained solvent surrounding the dried blood spot to assist in elution of the analyte of interest from the DBS. The tips may be immersed within 90% of their total tip length. The water contained within the ultrasonic station is used only to transmit ultrasonic frequency to the DBS. This water is normally prevented from entering the tip or tips. The pipette tips may further include a suitable sorbent within the orifice end of the cannula for solid phase extraction or protein precipitation extraction.

In other aspects, the invention is directed to a method for extracting an analyte of interest from a dried blood spot, whereby the dried blood spot is contained within a pipette tip or tips. The pipette tips are installed on a suitable pipette assembly to allow soaking of the DBS in a suitable solvent for a period of time, or by agitation of the eluting solvent with multiple aspirate and dispense motions that move the elution solvent back and forth across the contained dried blood spot, or immersing the tip or tips in an ultrasonic bath to facilitate disruption of the dried blood spot with ultrasonic frequencies, or combinations of all three methods. The analyte eluted from the DBS is dispensed to a collection plate while the solid phase filtration media remains and is contained within the upper barrel of the pipettor tip.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a front view of a polypropylene pipette tip of one or more embodiments of the invention.

FIG. 2 is a cross sectional view of the polypropylene pipette tip of FIG. 1.

FIG. 3 is a cross sectional view of a 96 well automated pipetting head assembly with pipette tips of the invention and an ultrasonic tip washing station.

FIG. 4 is a perspective view of an ultrasonic tip washing station in accordance with the invention.

FIG. 5 is a cross sectional view of the ultrasonic tip washing station of FIG. 4.

FIG. 6 is a cross sectional view of a pipette tip of one or more embodiments of the invention after aspirating a volume (50 μL) of organic elution solvent and 90 μL of air.

FIG. 7 is a cross sectional view of the pipette tip of FIG. 6 after the organic liquid has equilibrated the vapor pressure within the tips dead air space.

FIG. 8 is a cross sectional view of the pipette tip of FIG. 7 after aspirating an additional amount of air to create a small liquid seal.

FIG. 9 is a cross sectional view of the pipette tip of FIG. 8 after dispensing the mixing volume of organic elution solvent.

FIG. 10 is a cross sectional view of the pipette tip of FIG. 9 after aspirating the mixing volume of organic elution solvent.

FIG. 11 is a cross sectional view of the pipette tip of FIG. 10 after dispensing the elution solvent to the bottom of the well in the destination plate.

FIG. 12 is a cross sectional view of the pipette tip of FIG. 11 after aspirating the elution solvent from the bottom of the well.

FIG. 13 is a cross sectional view of the pipette tip of FIG. 12 containing a desired volume of sorbent at the exit end of the tip cannula.

### DESCRIPTION OF THE PREFERRED EMBODIMENT(S)

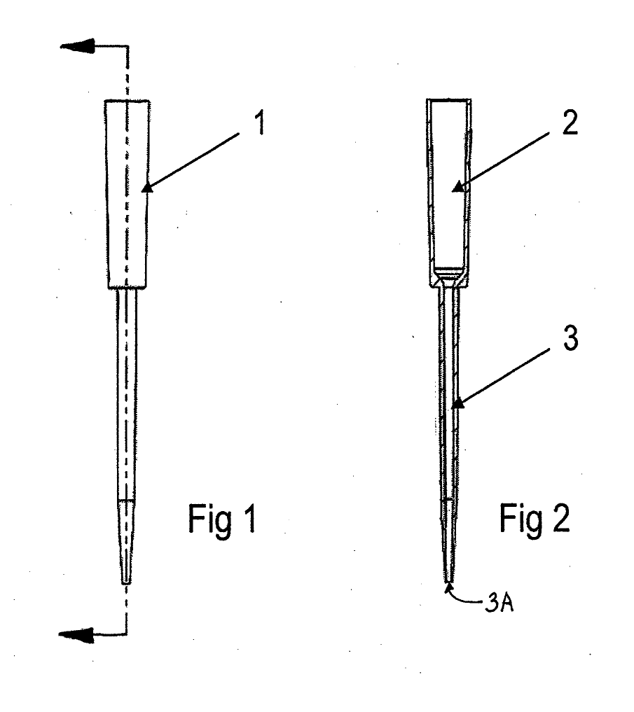

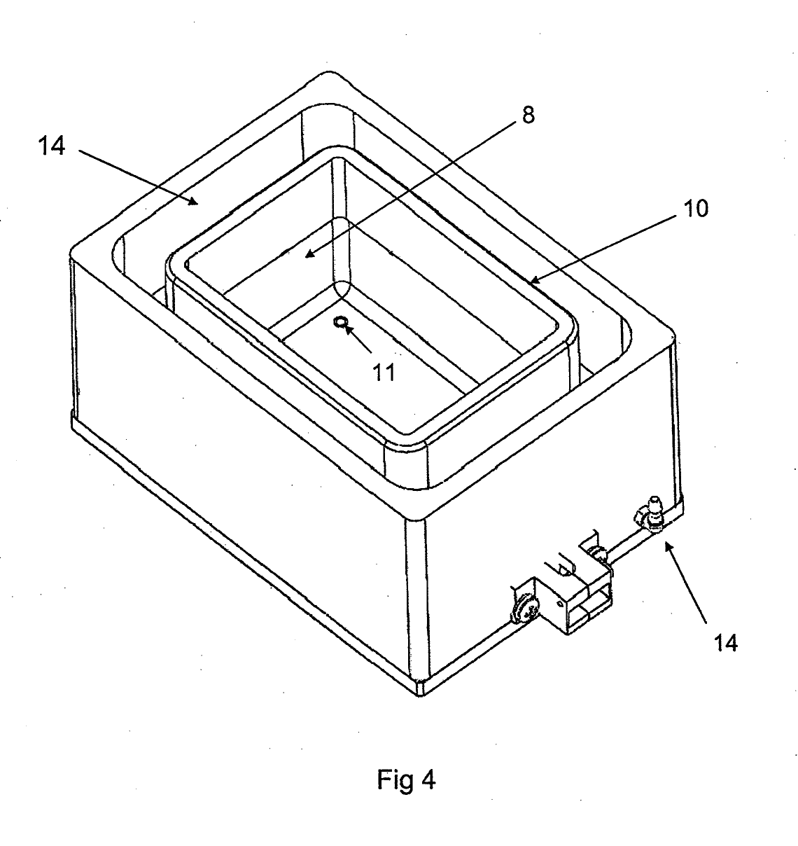

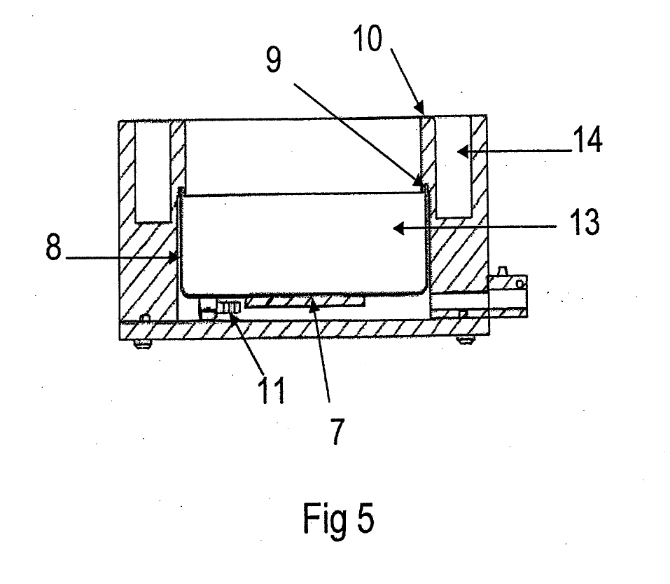

In describing the preferred embodiment of the present invention, reference will be made herein to FIGS. 1-13 of the drawings in which like numerals refer to like features of the invention. Terms such as “upper”, “lower”, “inner”, “outer”, “inwardly”, “outwardly”, “vertical”, “horizontal”, and the like, when used herein, refer to the positions of the respective elements shown in the accompanying figures and the present invention is not limited to such positions.

Referring to the invention, FIG. 1 shows a front view of a pipette tip 1 in accordance with one or more embodiments of the invention, while FIG. 2 shows a cross sectional view of such pipette tip 1. Preferably, the pipette tip 1 is fabricated by injection molding using a polypropylene resin material. The pipette tip 1 includes an upper barrel 2 and a lower cannula 3. While not deviating from the novel concepts of the invention, it should be appreciated that the pipette tips of the invention may be fabricated as and comprise a single monolithic piece, or alternatively, they may be fabricated as separate components whereby the upper barrel and lower cannula are securely attached together (e.g., either permanently attached together or removably attached together).

In one or more embodiments, the maximum working volume of liquid (e.g., water) for the entire pipette tip 1 (i.e., upper barrel 2 and cannula 3 in combination) may range from about 275 μL to about 650 μL, and is preferably about 450 μL. The lower cannula 3 may contain a liquid volume (e.g., water) ranging from about 75 μL to about 150 μL, and is preferably about 90 μL. The lower cannula 3 is connected to the upper barrel 2, which may contain a liquid volume ranging from about 200 μL to about 500 μL, preferably about 360 μL, thereby providing the total tip volume of 450 μL. The lower cannula 3 portion of the pipette tip 1 has a length that is long enough to allow the cannula to reach the bottom of a microplate well (e.g., an SBS/ANSI 96 well deepwell microplate).

The inner diameter of the top of the cannula 3 (i.e., where the cannula 3 connects to the upper barrel 2) ranges from about 0.05 inches to about 0.15 inches, and is preferably about 0.07 inches. The orifice 3A at the entry end of the pipette tip 1 has a diameter ranging from about 0.025 inches to about 0.04 inches, and is preferably about 0.03 inches.

The inside diameter of the lower cannula 3 (i.e., the “bore” of the cannula 3) is configured to allow an air gap ranging from about 5 μL to about 10 μL be used to separate individual aliquots of liquid contained in the cannula 3. Preferably, the air gap within the bore of the cannula 3 ranges from about 5 μL to 10 μL for separating aliquots of liquid retained within the 90 μL total volume of the lower cannula. Air gap separation of aliquots may or may not be available in the wider diameter of the upper barrel portion of the tip.

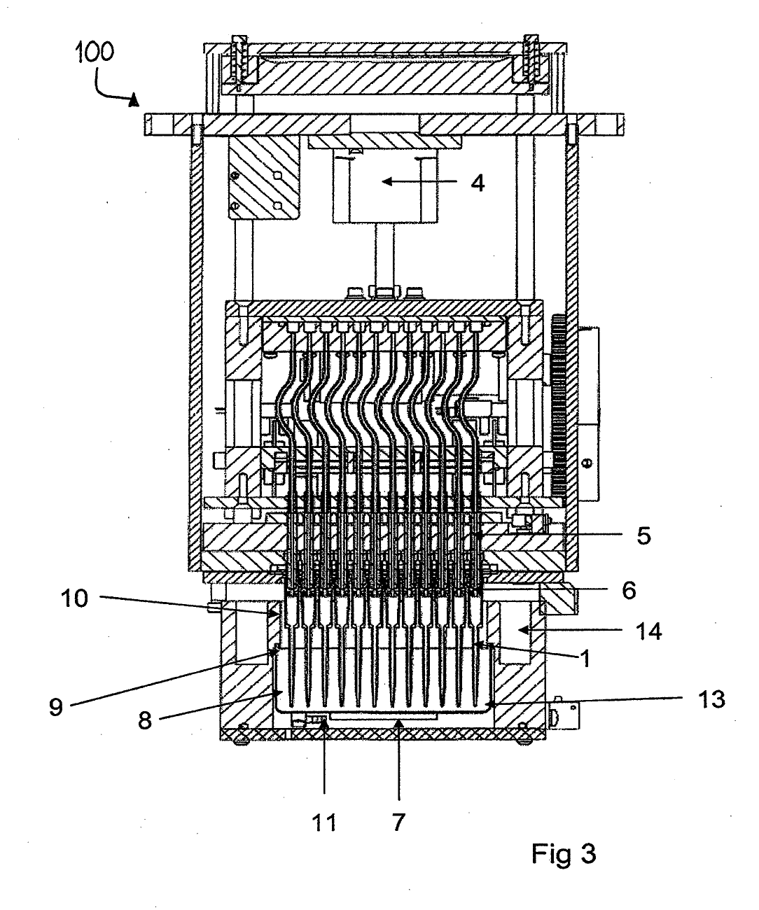

In one or more embodiments a single rack of pipette tips 1 is provided for use on a 96 well automated pipetting system, such as the automated pipetting system 100 of the invention shown in FIG. 3. Conventional automated pipetting systems for processing DBS require the use of multiple microplates and disposable elements. On the contrary, the present invention requires only a single disposable element. In particular, the present automated pipetting system 100 requires only a single disposable rack of 96 pipette tips designed for use with a 96 well microplate.

The automated pipetting system 100 of the invention includes a stepper motor 4 that is controlled by pipetting system 100 software. The stepper motor 4 is controlled to move a plurality of pistons 5 (e.g., 96 pistons) for displacing an equivalent volume of air. A plurality of pipette tips 1 are attached to the pistons 5, whereby one tip is attached to one piston. Preferably, the plurality of pipette tips 1 are supported in a single pipette tip rack, whereby from 1 to 96 tips may be placed in the rack.

The primary function of the pipette tip rack is to support the pipette tips during the pipette tip loading and/or removal processes. The pipette tip rack provides ease of loading and unloading of the pipette tips 1, and may be removed and/or replaced after the initial tip loading process. While the pipette tip rack is a preferred component of one or more embodiments of the invention, it should be appreciated and understood that other equivalent components and methods may be used for pipette tip 1 loading and/or removal from the automated pipetting system 100.

Wherein a plurality of pipette tips 1 are retained within a pipette tip rack, the pipette tip rack having the plurality of pipette tips 1 is loaded into the system 100. The pipette tips 1 are forced onto piston tip pins 6 of the pistons 5, whereby an “O” ring seal of the piston tip pin 6 seals each pipette tip 1 to its respective piston 5. In accordance with the invention, from 1 to 96 pipette tips 1 may be attached and sealed to the pistons 5. In so doing, as each piston 5 moves its respective pipette tip 1 also moves to the displacement action of the piston's motion, thereby displacing a volume of air, as well as an equivalent volume of liquid is aspirated or dispensed from the pipette tip(s) 1 attached to such pistons 5.

The automated pipetting system 100 of the invention also includes an ultrasonic tip washing station as is shown in FIGS. 3-5. This ultrasonic tip washing station preferably is of sufficient depth to allow the length of the pipette tip 1 to be submerged in water that is retained within the ultrasonic tip washing station. In so going, the ultrasonic frequencies interact with the contents of the pipette tip 1.

In one or more embodiments, the ultrasonic tip washing station includes an ultrasonic transducer 7 driven by an electrical connection to an external control unit (not shown). This transducer 7 is bonded to the bottom of a stainless steel pan 8 for transmitting ultrasonic frequency to water 13 contained within the stainless steel pan 8. The stainless steel pan 8 is preferably sealed to a polypropylene enclosure 9, such that, when filled with water 13, such water 13 overflows a weir 10 at the top perimeter of the combined container. Water from an externally controlled source flows into the water chamber 13 at the bottom through a plumbing fitting 11. The water overflows the perimeter weir 10 and is contained in a drain sump 14. The sump 14 in turn, is connected to an externally controlled drain. Typically a peristaltic pump may be used to circulate the water from the drain sump 14 back to the water chamber 13.

FIGS. 6-13 show cross sectional views of a pipette tip 1 in accordance with one or more embodiments of the invention. An essential feature of each pipette tip 1 is its ability to isolate liquid within various sectional areas of such pipette tip. A DBS is punched from a DBS slide or card, and then the punched DBS 25 is either manually or automatically (i.e., with mechanized methods) provided within the upper barrel 2 of a pipette tip 1. The punched DBS preferably has a diameter ranging from about 3 min to about 6 mm, or even larger.

The punched DBS 25 resides at the orifice between the upper barrel 2 and cannula 3. In those embodiments implementing a 3 mm (i.e., 0.118 inches) DBS 25 with a 0.07 inch opening between the upper barrel 2 and the cannula 3 (i.e., the inner bore of the cannula has a diameter of 0.07 inches at the location where it attaches to the upper barrel 2), then this 3 mm DBS 25 will not pass into the lower cannula 3 when placed in the upper barrel 2. It should be appreciated that the upper barrel 2 and cannula 3 may be configured so as to accommodate a 6 mm punched DBS 25, or even larger. Again, a plurality of these pipette tips 1, each having a punched DBS 25 residing in its upper barrel 2, may be positioned and secured within a pipette tip rack that holds 1 to 96 pipette tips arranged in an 8×12 array on 9 mm centers.

Once the punched DBS 25 are within the pipette tips 1, they are loaded on a 96 well automated pipetting system 100 of the invention and secured to the piston tip pins 6 thereof, as is shown in FIGS. 6-13. Again, each pipette tip 1 is sealed to its respective piston tip pins 6 by the “O” ring seal 16. Through program control of the automated system, as the mechanical piston 5 moves, liquid or air is aspirated into or dispensed out of the tip orifice 19 of pipette tip 1 by means of air displacement within such tip1.

Referring to FIG. 6, the pipette tips 1 are placed in a reservoir of a solvent that has been selected for the elution of the analyte from the DBS. A predetermined volume of the solvent is aspirated into the lower cannula 3 of the tips 1 to provide an elution volume 18 therein, the pipette tips 1 removed from the solvent reservoir, and then a predetermined volume of air is aspirated into the tips to move elution volume 18 from the cannula 3 and into the upper barrel 2 of the pipette tip 1. The aspirated air remains within the cannula 3.

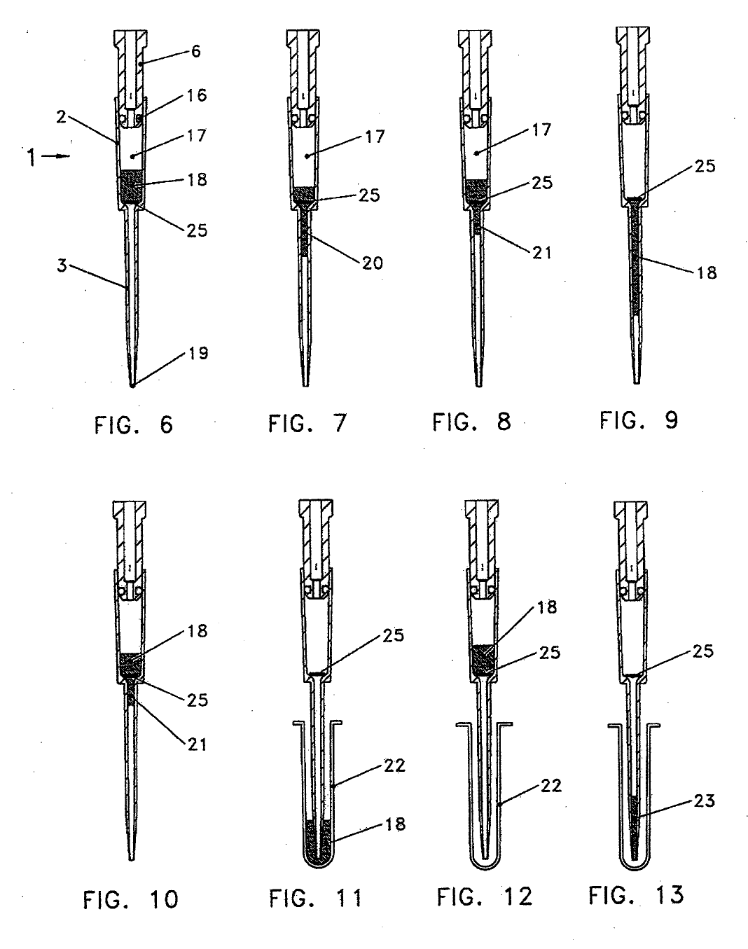

For instance, in one or more embodiments, about 50 μL of a liquid solvent elution volume 18 is aspirated into the cannula 3 followed by aspirating 90 μL of air into such cannula 3 to move the 50 μL of solvent from the cannula 3 and into the upper barrel 2. The lower cannula will have 90 μL of air. In certain embodiments the elution solvent is preferably an organic solvent, such as, but not limited to, methanol (MeOH), acetonitrile (ACN), and the like. As the organic moves into the closed pipette tip 1, it immediately starts to evaporate into the dead air space 17 within the upper barrel 2 portion of the tip1. The evaporating organic decreases the negative pressure within the pipette tip 1 that was generated by the piston 5 to equilibrate the vapor pressure within the tips 1 dead air space. This in turn reduces the negative pressure that is supporting the column of liquid within the upper barrel 2 of the tip 1, thereby allowing a volume 20 of the aspirated liquid solvent to move back down into the lower cannula 3, as is shown in FIG. 7.

Once the liquid solvent is aspirated from the elution solvent reservoir into the pipette tips 1, such elution solvent reservoir is removed from contacting the pipette tip orifices. This reservoir is then replaced with a 96 well SBS/ANSI microplate, conventional well or deepwell, that serves as the destination plate 22 (FIG. 12). The microplate is positioned in relation to the pipette tips 1 so that the tip orifices 19 are near, but not pinned, to the bottom of the microplate wells.

After allowing the organic solvent to equilibrate the tip dead air space 17 in FIG. 7, an additional corrective volume of air is aspirated into the tip 1. Referring to FIG. 8, this additional amount of air moves a majority of the organic solvent back into the upper barrel 2, except for an amount sufficient enough remaining within the cannula 3 portion, to generate a liquid seal within the tip 1. For instance, in those embodiments implementing 50 μL of solvent and 90 μL of air, an additional amount of air is aspirated into the tip 1 to move a majority of the 50 μL of elution solvent back into the upper barrel 2, leaving about 5 μL to 10 μL of the solvent remaining within the cannula 3 (shown in FIG. 8 as reference numeral 21, which is a liquid seal 21 as discussed further below).

The volume of solvent remaining within the cannula 3 generates a liquid seal 21 within the cannula portion of the tip 1. This liquid seal prevents an air bubble from moving into the upper barrel 2 of the pipette tip, which is desirable since if an air bubble escapes from the lower cannula into the upper barrel, it would deplete the vacuum holding the liquid, thereby resulting in the loss of an equivalent amount of elution solvent down into and out of the lower cannula 3.

Once equilibrium has been established within the pipette tip 1, the organic liquid is stable and secure within the confines of such pipette tip. This enables different approaches of the invention for eluting the analyte of interest from the DBS residing within the pipette tip. These approaches may be implemented alone or in any combination thereof.

A first approach is to allow the DBS soak within the solvent for an amount of time sufficient for eluting the analyte from the DBS. In one or more embodiments, the analyte absorbed within the punched DBS is organic in nature, and as such, is easily and quickly soluble in the organic elution solvent.

A second approach is through the implementation of ultrasonic disruption. In so doing, the ultrasonic tip wash station shown in FIG. 4 is brought in position with the pipettor system of FIG. 3 so that the pipette tips 1 are immersed to almost their full length within the water level of the ultrasonic station. This allows the water to transmit ultrasonic frequencies to the contents of the pipettor tips. The disruption caused by the ultrasonic frequencies can be effective in releasing the analyte from the fibers of the filtration media of the DBS slide or card that was used to contain the DBS into the elution solvent.

The third approach of elution is through agitation mixing of the DBS. This agitation mixing includes providing the elution solvent back and forth through the DBS one or more times to elute the analyte from the DBS. The agitation mixing may be performed and completed entirely within the pipette tip(s) 1, or it may be between the pipette tip(s) 1 and a destination plate 22.

In a first agitation mixing process, the analyte may be eluted from the DBS by a series of aspirate and dispense motions that move the organic elution solvent through and around the DBS. In so doing, referring to FIG. 9, substantially the entire solvent volume 18 is first moved back down in the cannula 3, followed by aspirating this volume back up into the upper barrel 2 while still maintaining the liquid seal 21 at the top of the cannula (FIG. 10). This motion may be repeated a number of times so that the elution solvent is brought back and forth, across and through the DBS to elute the analyte out of the DBS, which again is trapped or contained within the upper barrel 2 of the pipette tip 1.

In a second agitation mixing process, the analyte may be eluted from the DBS by mixing agitation. Referring to FIGS. 11 and 12, in this approach the organic elution solvent is mixed between the upper barrel 2 and destination plate 22 (FIG. 12). The orifice 19 of the pipette tip(s) 1 is positioned near the bottom of the well in the 96 well destination plate 22, and the solvent volume 18 is then aspirated and dispensed between the tip 1 from the upper barrel 2, through the DBS 25, into the destination plate 22, and then back into the tip, up through the DBS 25 and into the upper barrel 2. The mixing volume is equal to the elution solvent volume (e.g., 50 μL) plus the air volume (e.g., 90 μL) in the cannula.

In one or more embodiments, the mixing approached is preferred since this agitation by mixing provides consistent and substantially equivalent elution results across the numerous pipette tips 1 that may be implemented within a single run. This approach is also less susceptibly to variation between pipette tips 1 that may be caused by differences between sample blood spots, or organic equilibration variances. However, it should be appreciated that the method chosen is ultimately dependent upon a number of factors including, but not limited to, the constituents of the elution solvent (e.g., organic or aqueous, or a combination of both in varying amounts), size of DBS, density of DBS, sample or analyte to be eluted from the DBS, the type and physical characteristics and properties of the filtration media of the DBS, and the like, or even any combination thereof.

Referring to FIG. 13, once the analyte is eluted from the DBS, whether by soaking, ultrasonic disruption or mixing agitation, the solution containing the analyte is finally dispensed down and out the tip orifice 19 of the pipette tips 1 into the destination plate 22. The DBS 25 remains within the upper barrels 2 of the pipette tips 1.

Optionally in one or more embodiments, prior to dispensing the eluent (i.e., the analyte containing solution) a sorbent material 23 may be provided within the lower portion of the cannula 3. The sorbent material 23 allows the “cleaning up” of the eluent prior to it being dispensed from the present pipette tips 1 for subsequent processing (e.g., processing by LC-MS). The sorbent material may include, but is not limited to, a filtration media to filter out any particulate matter from the eluent. For instance, protein precipitation from the DBS 25 may be filtered out of the eluent prior to it reaching the destination plate 22. The sorbent material may also include a chromatography sorbent, such as for use in solid phase extraction, to selectively bind or retain certain unwanted elements in the eluent.

The various embodiments of the invention advantageously prepare and elute an analyte from a DBS within a single, disposable pipette tip for subsequent analytical detection processing. These processes may include liquid chromatography and mass spectroscopy, LC-MS or LC-MS-MS. The various embodiments of the invention minimize the number of processing steps (e.g., pipetting steps) required for eluting and analyzing an analyte or sample from a DBS, minimize the amount of equipment and/or disposable elements necessary for eluting and analyzing an analyte or sample from a DBS, and provide easy and efficient extraction of an analyte or sample from a DBS that simplify and expedite the transfer and introduction of an eluted analyte/sample into analyte detection equipment, e.g., LC/MS, LC/MS/MS, and the like.

While the present invention is described in relation to dried blood samples, it should be appreciated and understood that invention is suitable for use in conjunction with any type of sample that is dried on a specimen collection card. For instance, specimen collection slides may collect preclinical and/or clinical samples or specimens including, but not limited to, one or more purely biological samples, one or more purely chemical samples, or the specimens may be a combination of one or more biological and chemical samples. For instance, a purely biological sample may include, but is not limited to, blood, saliva, bodily secretions, organic matter, and the like. A purely chemical sample may include, but is not limited to, a drug, an analyte, an organic or inorganic chemical compound, and the like. A sample that includes both biological and chemical components, may include, but is not limited to, a blood sample being tested for presence of a drug, bodily secretions being tested for presence of an organic or inorganic chemical compound, such as, a contaminant (e.g., a poison), and the like.

In the embodiments of the present invention described herein, it will be recognized that individual elements and/or features thereof are not necessarily limited to a particular embodiment but, where applicable, are interchangeable and can be used in any selected embodiment even though such may not be specifically shown or described.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A pipette tip for eluting an analyte comprising:
a pipette tip having an upper barrel and a lower cannula, the cannula having a smaller diameter at a location where the cannula meets the upper barrel; and
a securing ledge within the upper barrel at said location where the cannula and upper barrel meet each other for positioning and securing a piece of filtration media containing an analyte that is to be eluted from said filtration media.

3. The apparatus of claim 1 wherein the pipette tip is a single monolithic tip.

4. The apparatus of claim 1 wherein the upper barrel and lower cannula are distinct pieces secured together to form the pipette tip.

5. The apparatus of claim 1 wherein the pipette tip comprises a polypropylene resin material.

6. The apparatus of claim 1 wherein said location where the cannula and upper barrel meet each other has a diameter that prevents a piece of filtration media having a diameter ranging from about 3 mm to about 6 mm from passing from the upper barrel into the lower cannula.

7. The apparatus of claim 1 wherein said piece of filtration media comprises a dried blood spot collected from a filtration collection card or slide.

8. A pipetting system for eluting an analyte comprising:
a pipette tip having an upper barrel and a lower cannula, the cannula having a smaller diameter at a location where the cannula meets the upper barrel;
a securing ledge within the upper barrel at said location where the cannula meets the upper barrel;
a piece of filtration media containing an analyte for eluting from said filtration media, the filtration media residing within the upper barrel and being secured by the securing ledge therein;
a solvent within the pipette tip; and
a piston attached and sealed to the pipette tip for moving at least a portion of the solvent across and through the filtration media for elution of the analyte from the filtration media.

9. The system of claim 8 wherein said piece of filtration media comprises a dried blood spot collected from a filtration collection card or slide.

10. The system of claim 8 further including a plurality of said pipette tips.

11. The system of claim 8 further including an automated pipetting system for eluting the analyte from the filtration media within the pipette tip.

12. The system of claim 11 further including an ultrasonic tip washing station analyte for eluting the analyte from the filtration media within the pipette tip.

13. The system of claim 8 further including a sorbent material residing in the cannula of the pipette tip for filtering or treating an eluent comprising the solvent containing the eluted analyte prior to the eluent being discharged from the pipette tip.

14. A method for eluting an analyte comprising:
providing a pipette tip having an upper barrel and a lower cannula, the cannula having a smaller diameter at a location where the cannula meets the upper barrel, such that, a securing ledge resides within the upper barrel at said location where the cannula meets the upper barrel;
providing a piece of filtration media containing an analyte into the upper barrel of the pipette tip;
attaching and sealing the pipette tip to a piston residing within an automated pipetting system;
generating a pressure within the pipette tip by movement of the piston for providing a solvent into the lower cannula of the pipette tip, the solvent being suitable for eluting the analyte from the filtration media;
moving the solvent from the lower cannula, across and through the filtration media containing the analyte, and into the upper barrel;
eluting the analyte from the filtration media into the solvent; and
dispensing the analyte containing solvent from the pipette tip.

15. The method of claim 14 wherein the analyte is eluted from the filtration media by allowing the filtration media to soak in the solvent for a sufficient time.

16. The method of claim 14 wherein the analyte is eluted from the filtration media by ultrasonic agitation.

17. The method of claim 14 wherein the analyte is eluted from the filtration media by mixing agitation.

18. The method of claim 14 further including a sorbent material residing in the cannula of the pipette tip.

19. The method of claim 18 wherein the sorbent material comprises a filtration media for filtering out particulate matter from the eluent prior to the eluent being discharged from the pipette tip.

20. The method of claim 18 wherein the sorbent material comprises a chromatography sorbent for solid phase extraction.
